(19) United States
(12) Patent Application Publication
(10) Pub. No.: US 2024/0393524 A1
(43) Pub. Date: Nov. 28, 2024

(54) A LIGHT-EMITTABLE GLASS-BASED ARTICLE

(71) Applicant: SAINT-GOBAIN GLASS FRANCE, COURBEVOIE (FR)

(72) Inventors: Siteng MA, SHANGHAI (CN); Jeff PEET, SOUTHBOROUGH, MA (US); Michael LABROT, HERZOGENRATH (DE); Laurent MAILLAUD, MASSY (FR)

(21) Appl. No.: 18/693,055

(22) PCT Filed: Sep. 28, 2022
(86) PCT No.: PCT/CN2022/122331

§ 371 Date: Mar. 18, 2024

(30) Foreign Application Priority Data
Sep. 30, 2021 (CN) 202111165959.7

(51) Int. Cl. F21V 8/00; B32B 1/00; B32B 3/04; B32B 7/023; B32B 17/10; B60Q 3/208; B60Q 3/62

(52) U.S. Cl. CPC G02B 6/0095; B32B 1/00; B32B 3/04; B32B 7/023; B32B 17/10036; B32B 17/10541; B32B 17/10761; B32B 17/10788; G02B 6/009; B32B 2307/418; B60Q 3/208; B60Q 3/62

(57) ABSTRACT

A light-emittable glass-based article, wherein the article includes a glass having a curvature or being flat. The article is suitable for architectural or automotive glass, in particular automotive roof glass.

### TECHNICAL FIELD

The present application provides a light-emittable glass-based article, which includes a glass having a curvature or being flat. The article is suitable for architectural or automotive glass, in particular, automotive roof glass.

### BACKGROUND OF THE INVENTION

Glass has been widely used in various applications, such as architectural or automotive glass. Glass with integrated light emitting function is desirable because it provides more convenience. Light-emittable glass not only provides light emitting function, but also provides good commercial and visual effects.

DE102017127746 A1 discloses a light-emittable glass, which includes an LED light source encapsulated in the glass surface. The transparent glass needs to encapsulate the LED light source onto the surface of the glass through an injection molding process. However, the injection molding process for encapsulation is relatively complicated. Moreover, when the LED light source cannot work, it is difficult to repair it by replacing the light source. Besides, LED light source may potentially cause glare.

It is desirable in the art to provide a light-emittable glass with a curvature to accommodate increasing applications. A glass with a curvature is usually prepared by the following process: cut a flat raw glass plate into a pre-determined size; soften the flat glass plate and bend it to a desired curvature at a temperature of 600-700° C. The preparation of a light-emittable glass with a curvature requires that the light-emittable element can withstand the high temperature environment for achieving the curvature. Furthermore, subsequent high temperature and high pressure treatment (about 100-150° C., 10-15 bars) is required to eliminate any air gaps or bubbles on the surfaces of the light-emittable element and glass with a curvature, thereby providing a satisfactory light-emittable performance.

### SUMMARY OF THE INVENTION

The present application provides a light-emittable glass-based article, wherein the article includes a glass having a curvature or being flat. The article is suitable for architectural or automotive glass, in particular the automotive roof glass.

The light-emittable glass-based article of the present application includes:
a glass, having two opposing sides and a thickness defining the distance between the two sides, and, having a length and a first end surface and a second end surface defining the length;
a light isolating layer disposed on one side of the glass, the light isolating layer having a length and a first end surface and a second end surface defining the length;
a light guide layer disposed on the light isolating layer, the light guide layer including a first surface and a second surface opposite to the first surface, and a thickness defining the distance between the first surface and the second surface, and the light guide layer having a length and a first end surface and a second end surface defining the length, wherein the light guide layer is disposed on the light isolating layer through the first surface and allows light to propagate therein in a total reflection manner; and the light guide layer further includes an output light reorienting element for guiding light out of the light guide layer.

The output light reorienting element is used to guide light out of the light guide layer, and the output light reorienting element can be disposed in the light guide layer, on the first surface of the light guide layer, or on the second surface of the light guide layer, or a combination thereof.

In a preferred embodiment, the glass is a glass having a curvature. In another preferred embodiment, the glass is a glass being flat.

In a preferred embodiment, the light-emittable glass-based article has an edge encapsulation material. In a preferred embodiment, the first end surface and/or the second end surface of the glass, the light isolating layer and the light guide layer have an edge encapsulation material.

In one embodiment, the glass-based article further includes a light inlet, used for accepting light emitted from a light source.

In one embodiment, the light inlet is on the first end surface of the light guide layer.

In one embodiment, the light inlet is on the first surface of the light guide layer. Preferably, the light inlet is on the first surface of the light guide layer and adjacent to the first end surface and/or the second end surface.

The glass, the light isolating layer and the light guide layer can have substantially the same length or different lengths respectively.

The length of the glass described herein can be orthogonal to the thickness of the glass.

The length of the light isolating layer described herein can be orthogonal to the thickness of the light isolating layer.

The length of light guide layer described herein can be orthogonal to the thickness of the light guide layer.

In a preferred embodiment, the length of the light guide layer is greater than the length of the glass and/or the length of the light isolating layer. A part of the length of light guide layer that is longer than the length of the glass and/or the length of the light isolating layer is referred to as an extension part of the light guide layer. When the first end surface and/or the second end surface of the glass and/or the light isolating layer have an edge encapsulation material, the extension part of the light guide layer still exists. In a preferred embodiment, the light inlet is disposed on the extension part of the first surface of the light guide layer and adjacent to the first end surface and/or the second end surface of the light guide layer.

Distance between the light inlet and the outer side of the first end surface and/or the second end surface of the glass and/or the light isolating layer is represented by D1. When the first end surface and/or the second end surface of the glass and/or the light isolating layer are provided with an edge encapsulation material, D1 is the distance between the light inlet and the outer surface of the edge encapsulation material of the first end surface and/or the second end surface of the glass and/or the light isolating layer. Preferably, D1 is greater than 0. Distance between the light inlet and the inner side of the first end surface of the light guide layer is represented by D2. Preferably. D2 is greater than 0. More preferably. D2 is within a range from greater than 0 to 2 cm, for example, less than 2.00 cm, for example 1.99, 1.98, 1.97, 1.96, 1.95, 1.94, 1.93, 1.92, 1.91, 1.90, 1.89, 1.88, 1.87, 1.86, 1.85, 1.84, 1.83, 1.82, 1.81, 1.80, 1.79, 1.78, 1.77, 1.76, 1.75, 1.74, 1.73, 1.72, 1.71, 1.70, 1.69, 1.68, 1.67, 1.66, 1.65, 1.64, 1.63, 1.62, 1.61, 1.60, 1.59, 1.58, 1.57, 1.56, 1.55, 1.54, 1.53, 1.52, 1.51, 1.50, 1.49, 1.48, 1.47, 1.46, 1.45, 1.44, 1.43, 1.42, 1.41, 1.40, 1.39, 1.38, 1.37, 1.36, 1.35, 1.34, 1.33, 1.32, 1.31, 1.30, 1.29, 1.28, 1.27, 1.26, 1.25, 1.24, 1.23, 1.22, 1.21, 1.20, 1.19, 1.18, 1.17, 1.16, 1.15, 1.14, 1.13, 1.12, 1.11, 1.10, 1.09, 1.08, 1.07, 1.06, 1.05, 1.04, 1.03, 1.02, 1.01, 1.00, 0.99, 0.98, 0.97, 0.96, 0.95, 0.94, 0.93, 0.92, 0.91, 0.90, 0.89, 0.88, 0.87, 0.86, 0.85, 0.84, 0.83, 0.82, 0.81, 0.80, 0.79, 0.78, 0.77, 0.76, 0.75, 0.74, 0.73, 0.72, 0.71, 0.70, 0.69, 0.68, 0.67, 0.66, 0.65, 0.64, 0.63, 0.62, 0.61, 0.60, 0.59, 0.58, 0.57, 0.56, 0.55, 0.54, 0.53, 0.52, 0.51, 0.50, 0.49, 0.48, 0.47, 0.46, 0.45, 0.44, 0.43, 0.42, 0.41, 0.40, 0.39, 0.38, 0.37, 0.36, 0.35, 0.34, 0.33, 0.32, 0.31, 0.30, 0.29, 0.28, 0.27, 0.26, 0.25, 0.24, 0.23, 0.22, 0.21, 0.20, 0.19, 0.18, 0.17, 0.16, 0.15, 0.14, 0.13, 0.12, 0.11, 0.10, 0.09, 0.08, 0.07, 0.06, 0.05, 0.04, 0.03, 0.02, 0.01, 0.00 cm.

The term “substantially” means that the difference between objects involved are less than 0.1% or 0.01% on the premise of the same unit. The term “about” is meant to encompass variations of +5% from the stated value.

In one embodiment, the light guide layer described herein usually has a good light transmittance, for example, the light transmittance of the light guide layer described herein is about 80-100%, for example, greater than or equal to about 80%, greater than or equal to about 81%, greater than or equal to about 82%, greater than or equal to about 83%, greater than or equal to about 84%, greater than or equal to about 85%, greater than or equal to about 86%, greater than or equal to about 87%, greater than or equal to about 88%, greater than or equal to about 89%, greater than or equal to about 90%, greater than or equal to about 91%, greater than or equal to about 92%, greater than or equal to about 93%, greater than or equal to about 94%, greater than or equal to about 95%, greater than or equal to about 96%, greater than or equal to about 97%, greater than or equal to about 98%, greater than or equal to about 99%, or for example, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99%.

The light isolating layer described herein includes one or more fluoropolymers, polysiloxanes, acrylate polymers, and epoxy resins, or a combination thereof. The light isolating layer described herein further includes one or more thermoplastic materials, and curable materials, or a combination thereof. The light isolating layer described herein further includes one or more pressure sensitive adhesives, optically transparent adhesives, and primers, or a combination thereof.

The light guide layer of the present application can adopt a material selected from one or more: polyurethanes, polycarbonates, acrylate polymers, polyesters, and cellulose acetates, or a combination thereof. The light guide layer described herein further includes one or more thermoplastic materials, and curable materials, or a combination thereof. The light guide layer described herein further includes an optically transparent adhesive. The light guide layer described herein can include a glass.

The fluoropolymer described herein refers to a polymer containing a fluorine atom in its molecule. The fluoropolymer described herein includes one or a combination of more of ethylene-tetrafluoroethylene copolymer (ETFE), fluorinated ethylene propylene copolymer (FEP), and polyvinylidene fluoride (PVDF).

The polysiloxane described herein refers to a polymer containing a (—Si—O—) repeating unit in the backbone. Polysiloxane can also be called silicone. Polysiloxane and silicone can be used interchangeably. In this context, polysiloxane liquid is called silicone oil, polysiloxane rubber is called silicone rubber, and polysiloxane resin is called silicone resin. Polysiloxane described herein includes one or a combination of more of silicone oil, silicone rubber, and silicon resin.

The acrylate polymer described herein refers to any polymer containing a repeating unit derived from acrylate. The repeating unit can be substituted or unsubstituted, as allowed by valence. The acrylate polymer can be homopolymer and/or copolymer. The acrylate polymer described herein includes one or a combination of more of polymethyl acrylate, polyethyl acrylate, polypropyl methacrylate, polymethyl methacrylate, polyethyl methacrylate, and polypropyl methacrylate.

The epoxy resin described herein refers to the polymer obtained after polymerization of substances containing an epoxy bond. The epoxy resin includes one or a combination of more of bisphenol A epoxy resin, halogenated bisphenol A epoxy resin, phenolic epoxy resin, cycloaliphatic epoxy resin, and bisphenol S epoxy resin.

The thermoplastic material described herein refers to a material that can flow and deform when heated, and can harden after cooling. The thermoplastic material described herein includes one or a combination of more of polyethylene terephthalate, polybutylene terephthalate, cellulose acetate, ethylene-vinyl acetate polymer, polycarbonate, polyvinyl butyral (PVB), polyethylene, polypropylene, polyvinyl chloride, polystyrene, polyoxymethylene, polyamide, polysulfone, polyphenyl ether, and chlorinated polyether.

The curable material described herein refers to a material that can transform from a non-fixed shape to a fixed shape under light or heat conditions. The curable material described herein includes one or a combination of more of phenolic resin, urea formaldehyde resin, melamine resin, unsaturated polyester resin, epoxy resin, silicone resin, and polyurethane. The curable material described herein further includes one or more precursor materials for preparing the desired curable material, wherein the one or more precursor materials can be in the form of mixed state or separated state.

The pressure sensitive adhesive described herein refers to a substance that becomes viscous under a certain pressure, with a peeling force less than a cohesive force. The pressure sensitive adhesive described herein includes one or a combination of more of rubber pressure sensitive adhesive, polyurethane pressure sensitive adhesive, acrylate polymer pressure sensitive adhesive, and polysiloxane pressure sensitive adhesive.

The optically transparent adhesive described herein usually refers to a class of substance with a good light transmittance (for example, 90% or higher), and a good bond strength. The optically transparent adhesive described herein can be cured at an appropriate temperature (for example, at the room temperature or under a heating condition), and has a small curing shrinkage rate. The optically transparent adhesive described herein includes one or a combination of more of silicone resin, epoxy resin, and acrylate.

The primer described herein refers to the first layer of paint applied directly on the treated or untreated surface. The primer described herein has a good light transmittance.

The polyurethane described herein refers to a polymer containing a urethane (—NH—COO—) repeating unit in the backbone. The polyurethane is obtained by the reaction of polyisocyanate (including diisocyanate) and polyol (including diol) and optionally auxiliary additive. The types of polyisocyanate, polyol and auxiliary additive used in the preparation of polyurethane are well known to those skilled in the art. According to the processing technology, polyurethane (PU) can be classified as thermoplastic polyurethane (TPU), cast polyurethane (CPU) and millable polyurethane (MPU).

Polycarbonate (PC) refers to a polymer containing a carbonate group in the backbone. Polycarbonate can be classified as many types, such as aliphatic polycarbonate, aromatic polycarbonate, and aliphatic-aromatic polycarbonate.

The polyester described herein refers to a polymer obtained by polycondensation of polyol and polyacid. Polyester includes polyethylene terephthalate (PET), polybutylene terephthalate (PBT) and polyarylate (PAR), etc.

The cellulose acetate described herein refers to a chemically modified polymer substance obtained by esterifying the hydroxyl group in the cellulose molecule with acetic acid. Cellulose acetate includes cellulose monoacetate, cellulose diacetate, cellulose triacetate, etc. Cellulose triacetate usually refers to cellulose acetate with a degree of esterification of greater than or equal to 2.7.

In one embodiment, the refractive index of the light guide layer described herein is greater than the refractive index of the light isolating layer. In one embodiment, the ratio of the refractive index of the light guide layer to the refractive index of the light isolating layer described herein is greater than or equal to about 1.01, 1.02, 1.03, 1.04, 1.05, 1.06, 1.07, 1.08, 1.09, 1.10, 1.11, 1.12, 1.13, 1.14, 1.15, 1.16, 1.17, 1.18, 1.19, 1.20. In one embodiment, the ratio of the refractive index of the material of the light guide layer to the refractive index of the material of the light isolating layer described herein is in the range from about 1.01 to 1.20, for example about 1.01, 1.02, 1.03, 1.04, 1.05, 1.06, 1.07, 1.08, 1.09, 1.10, 1.11, 1.12, 1.13, 1.14, 1.15, 1.16, 1.17, 1.18, 1.19, 1.20.

In one embodiment, the refractive index of the light guide layer described herein is greater than the refractive index of the light isolating layer. In one embodiment, the difference between the refractive index of the light guide layer and the refractive index of the light isolating layer described herein is greater than or equal to about 0.01, 0.02, 0.03, 0.04, 0.05, 0.06, 0.07, 0.08, 0.09, 0.10, 0.11, 0.12, 0.13, 0.14, 0.15, 0.16, 0.17, 0.18, 0.19, 0.20, 0.21, 0.22, 0.23, 0.24, 0.25, 0.26, 0.27, 0.28, 0.29, 0.30. In one embodiment, the difference between the refractive index of the material of the light guide layer and the refractive index of the material of the light isolating layer described herein is in the range from about 0.01 to 0.30, for example 0.01, 0.02, 0.03, 0.04, 0.05, 0.06, 0.07, 0.08, 0.09, 0.10, 0.11, 0.12, 0.13, 0.14, 0.15, 0.16, 0.17, 0.18, 0.19, 0.20, 0.21, 0.22, 0.23, 0.24, 0.25, 0.26, 0.27, 0.28, 0.29, 0.30.

In one embodiment, the refractive index of the light isolating layer described herein is less than or equal to about 1.50, less than or equal to about 1.49, less than or equal to about 1.48, less than or equal to about 1.47, less than or equal to about 1.46, less than or equal to about 1.45, less than or equal to about 1.44, less than or equal to about 1.43, less than or equal to about 1.42, less than or equal to about 1.41, less than or equal to about 1.40, less than or equal to about 1.39, less than or equal to about 1.38, less than or equal to about 1.37, less than or equal to about 1.36, less than or equal to about 1.35, less than or equal to about 1.34, less than or equal to about 1.33, less than or equal to about 1.32, less than or equal to about 1.31, less than or equal to about 1.30, less than or equal to about 1.29, less than or equal to about 1.28, less than or equal to about 1.27, less than or equal to about 1.26, less than or equal to about 1.25.

In one embodiment, the refractive index of the light isolating layer described herein is in the range from 1.25 to 1.50, for example about 1.25, 1.26, 1.27, 1.28, 1.29, 1.30, 1.31, 1.32, 1.33, 1.34, 1.35, 1.36, 1.37, 1.38, 1.39, 1.40, 1.41, 1.42, 1.43, 1.44, 1.45, 1.46, 1.47, 1.48, 1.49, 1.50.

In one embodiment, the refractive index of the light guide layer described herein is less than or equal to about 1.80, less than or equal to about 1.79, less than or equal to about 1.78, less than or equal to about 1.77, less than or equal to about 1.76, less than or equal to about 1.75, less than or equal to about 1.74, less than or equal to about 1.73, less than or equal to about 1.72, less than or equal to about 1.71, less than or equal to about 1.70, less than or equal to about 1.69, less than or equal to about 1.68, less than or equal to about 1.67, less than or equal to about 1.66, less than or equal to about 1.65, less than or equal to about 1.64, less than or equal to about 1.63, less than or equal to about 1.62, less than or equal to about 1.61, less than or equal to about 1.60, less than or equal to about 1.59, less than or equal to about 1.58, less than or equal to about 1.57, less than or equal to about 1.56, less than or equal to about 1.55, less than or equal to about 1.54, less than or equal to about 1.53, less than or equal to about 1.52, less than or equal to about 1.51, less than or equal to about 1.50, less than or equal to about 1.49, less than or equal to about 1.48, less than or equal to about 1.47, less than or equal to about 1.46, less than or equal to about 1.45, less than or equal to about 1.44, less than or equal to about 1.43, less than or equal to about 1.42, less than or equal to about 1.41, less than or equal to about 1.40, less than or equal to about 1.39, less than or equal to about 1.38, less than or equal to about 1.37, less than or equal to about 1.36, less than or equal to about 1.35, less than or equal to about 1.34, less than or equal to about 1.33, less than or equal to about 1.32, less than or equal to about 1.31, less than or equal to about 1.30, less than or equal to about 1.29, less than or equal to about 1.28, less than or equal to about 1.27, less than or equal to about 1.26, less than or equal to about 1.25. In one embodiment, the refractive index of the light guide layer described herein is in the range from 1.25 to 1.80, for example about 1.25, 1.26, 1.27, 1.28, 1.29, 1.30, 1.31, 1.32, 1.33, 1.34, 1.35, 1.36, 1.37, 1.38, 1.39, 1.40, 1.41, 1.42, 1.43, 1.44, 1.45, 1.46, 1.47, 1.48, 1.49, 1.50, 1.51, 1.52, 1.53, 1.54, 1.55, 1.56, 1.57, 1.58, 1.59, 1.60, 1.61, 1.62, 1.63, 1.64, 1.65, 1.66, 1.67, 1.68, 1.69, 1.70, 1.71, 1.72, 1.73, 1.74, 1.75, 1.76, 1.77, 1.78, 1.79, 1.80.

In one embodiment, the light guide layer further includes an incidence reorienting element, for reorienting the incident angle of the light from the light inlet to the total reflection angle. In one embodiment, the incidence reorienting element is a waveguide element or a prism optical reorienting element, wherein the surface of the prism optical reorienting element has a high reflectivity. The angle of the prism can be adjusted to ensure that light propagates in a total reflection manner in the light guide layer.

In one embodiment, the output light reorienting element is a structured surface, a preset pattern, a concave, and/or a convex, etc. The preset pattern includes one or more dots, lines, rectangles, arrows, crosses, trapezoids, rectangles, squares, V-shapes, pentagons, hexagons, circles, ellipses, arcs, and a combination thereof.

In one embodiment, the second surface of the light guide layer contacts air.

In another embodiment, an optional protective layer is disposed on the second surface of the light guide layer. The protective layer can be a scratch-resistant layer or a fire-resistant layer. The protective layer should have a suitable low refractive index (for example, lower than the refractive index of the light guide layer by 0.03 or more) to ensure that the light is reflected at the interface between the light guide layer and the protective layer in a total reflection manner.

An example of the protective layer can be a hard coating, for example a polysiloxane hard coating.

In one embodiment, the refractive index of the light guide layer described herein is greater than the refractive index of the protective layer. In one embodiment, the ratio of the refractive index of the light guide layer to the refractive index of the protective layer described herein is greater than or equal to about 1.01, 1.02, 1.03, 1.04, 1.05, 1.06, 1.07, 1.08, 1.09, 1.10, 1.11, 1.12, 1.13, 1.14, 1.15, 1.16, 1.17, 1.18, 1.19, 1.20. In one embodiment, the ratio of the refractive index of the material of the light guide layer to the refractive index of the material of the protective layer described herein is in the range from about 1.01 to 1.20, for example, about 1.01, 1.02, 1.03, 1.04, 1.05, 1.06, 1.07, 1.08, 1.09, 1.10, 1.11, 1.12, 1.13, 1.14, 1.15, 1.16, 1.17, 1.18, 1.19, 1.20.

In one embodiment, the refractive index of the light guide layer described herein is greater than the refractive index of the protective layer. In one embodiment, the difference between the refractive index of the light guide layer and the refractive index of the protective layer described herein is greater than or equal to about 0.01, 0.02, 0.03, 0.04, 0.05, 0.06, 0.07, 0.08, 0.09, 0.10, 0.11, 0.12, 0.13, 0.14, 0.15, 0.16, 0.17, 0.18, 0.19, 0.20, 0.21, 0.22, 0.23, 0.24, 0.25, 0.26, 0.27, 0.28, 0.29, 0.30. In one embodiment, the difference between the refractive index of the material of the light guide layer and the refractive index of the material of the protective layer described herein is in the range from about 0.01 to 0.30, for example, 0.01, 0.02, 0.03, 0.04, 0.05, 0.06, 0.07, 0.08, 0.09, 0.10, 0.11, 0.12, 0.13, 0.14, 0.15, 0.16, 0.17, 0.18, 0.19, 0.20, 0.21, 0.22, 0.23, 0.24, 0.25, 0.26, 0.27, 0.28, 0.29, 0.30.

In one embodiment, the light isolating layer described herein includes one or a combination of more of:
(1) thermoplastic fluoropolymer, preferably ETFE, FEP, PVDF, ethylene tetrafluoroethylene, fluorinated ethylene propylene, polyvinylidene fluoride;
(2) silicone;
(3) acrylic with a refractive index of about 1.45 to 1.47 or lower;
(4) polysiloxane with a refractive index of about 1.43 or lower;
(5) optically transparent adhesive for glass lamination with a refractive index of about 1.3 or lower, preferably silicone resin, epoxy resin or acrylate;
(6) pressure sensitive adhesive (PSA) with a refractive index of about 1.45 to 1.47 or lower; or
(7) primer with low refractive index.

In one embodiment, the light guide layer described herein includes one or a combination of more of:
(1) thermoplastic polyurethane;
(2) polycarbonate;
(3) polymethylmethacrylate;
(4) PET, preferably PET with a refractive index greater than 1.5;
(5) cellulose triacetate;
(6) optically transparent adhesive, preferably optically transparent adhesive with a refractive index greater than 1.5; or
(7) other polyurethane.

In one embodiment, the light isolating layer has an appropriately low refractive index (for example, lower than the refractive index of the light guide layer by 0.03 or more) to ensure that the light is reflected at the interface between the light guide layer and the light isolating layer in a total reflection manner. Surprisingly, the light isolating layer of the present application can achieve a good attachment to the glass and/or the light guide layer, eliminating the air gap and/or air bubbles between contact surfaces. Moreover, the light isolating layer of the present application can withstand the post-treatment process with treatment including 2 hours under 140° C. and 13 bars. The light isolating layer can also achieve a good attachment to the glass and the light guide layer, for example, can achieve a peeling strength greater than 2 N/mm (for example greater than 3 N/mm, for example greater than 4 N/mm, for example greater than 5 N/mm, for example greater than 6 N/mm, for example greater than 7 N/mm, for example greater than 8 N/mm, for example greater than 9 N/mm, for example greater than 10 N/mm). The light isolating layer of the present application can achieve a good clarity, for example with a haze of <6% (for example, <5%, <4%, <3%, <2%, <1%) at 1 m, preferably a haze of <1%. In a preferred aspect, the light isolating layer of the present application also has the function of filtering ultraviolet and/or infrared light, and the function of blocking glass fragments. The light isolating layer of the present application has a thickness of 1-1000 μm, for example 1, 2, 3, 4, 5, 6, 7, 8, 9, 10, 15, 20, 25, 30, 35, 40, 45, 50, 55, 60, 65, 70, 75, 80, 85, 90, 95, 100, 150, 200, 250, 300, 350, 400, 450, 500, 550, 600, 650, 700, 750, 800, 850, 900, 950, 1000 μm.

In one embodiment, the light guide layer has a micro-structured surface, which is used as an output light reorienting element. The output light reorienting element is used to reorient the incident angle of the light propagating in the light guide layer in a total reflection manner to be less than the total reflection angle, allowing the light to exit from the light guide layer. The light guide layer of the present application can achieve a good clarity, for example with a haze of <6% (for example, <5%, <4%, <3%, <2%, <1%) at 1 m, preferably a haze of <1%. The light guide layer can also achieve a good attachment to the light isolating layer and the optional protective layer, for example achieve a peel strength of greater than 2 N/mm (for example greater than 3 N/mm, for example greater than 4 N/mm, for example greater than 5 N/mm, for example greater than 6 N/mm, for example greater than 7 N/mm, for example greater than 8 N/mm, for example greater than 9 N/mm, for example greater than 10 N/mm). In a preferred aspect, the light guide layer of the present application also has a function of filtering ultraviolet and/or infrared light, and a function of blocking glass fragments. The light guide layer has a thickness of 0.1-1.5 mm, for example 0.1, 0.2, 0.3, 0.4, 0.5, 0.6, 0.7, 0.8, 0.9, 1.0, 1.1, 1.2, 1.3, 1.5 mm. The light guide layer of the present application can also withstand the post-treatment process with treatment including 2 hours under 140° C. and 13 bars.

A glass (such as a glass having a curvature or being flat) described herein has a thickness of 0.1-5.0 mm, for example a thickness of 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0 mm.

The light-emittable glass-based article of the present application is suitable for various light sources. The light source can be a linear light source or a dot-shaped light source. The light source can be encapsulated in the glass-based article through an encapsulation process. Optionally, the light source can also be detachably connected to the glass-based article. Alternatively, a part of the light source has a convex shape and a part of the glass-based article has a concave shape, and the convex and the concave are complementary. The light source is preferably collimated, for example, a collimated LED light source. When the light source is perpendicular to the second surface of the light guide layer, the incident angle of the incident light is reoriented to the total reflection angle by the reorienting element.

Any polymer described herein can be a homopolymer and/or a copolymer. The copolymer includes random copolymers, block copolymers, etc.

The molecular weight of the polymer described herein can be a number average molecular weight or a weight average molecular weight.

Without being specified clearly, the content described herein can also be volume content or weight content. Those skilled in the art can easily determine it according to specific circumstances.

The temperature described herein refers to degrees Celsius.

The light-emittable glass-based article described herein might be an article having a curvature or being flat.

The light isolating layer of the present application can be prepared by the following processes: injection molding, thermal lamination, bonding, or coating. The bonding can use a pressure sensitive adhesive. The coating can be flow coating, spray coating, roll coating or sputter coating.

The light guide layer of the present application can be prepared by the following processes:
(1) mold injection encapsulation process;
(2) thermal lamination process; or
(3) other appropriate processes.

The light inlet of the present application can be prepared by the following methods:
(1) laser removal of the surface material of the layer;
(2) laser removal of the material in the layer;
(3) surface embossing and micro embossing; or
(4) printing, for example screen printing.

The output light reorienting element of the present application can be prepared by the following methods:
(1) laser removal of the surface material of the layer;
(2) laser removal of the material in the layer;
(3) surface embossing and micro embossing; or
(4) printing, for example screen printing.

### DESCRIPTION OF THE DRAWINGS

FIG. 1 shows an exemplary embodiment of the present application. The reference numbers are as follows: 1: glass; 2: light isolating layer; 3: light guide layer; 4: protective layer; 5: edge encapsulation material; and 6: light source.

FIG. 2 illustrates the light path in the light guide layer. The reference numbers are as follows: 1: glass; 2: light isolating layer; 3: light guide layer; 6: light source; 7: light; 8: output light reorienting element; and 9: light inlet.

FIG. 3 shows the first exemplary embodiment with the light source disposed on the second surface of the light guide layer. The reference numbers are as follows: 1: glass; 2: light isolating layer; 3: light guide layer; 6: light source; 7: light; and 8: output light reorienting element.

FIG. 4: shows the second exemplary embodiment with the light source disposed on the second surface of the light guide layer. The reference numbers are as follows: 1: glass; 2: light isolating layer; 3: light guide layer; 6: light source; 7: light; 8: output light reorienting element; and 10: incidence reorienting element.

FIG. 5 shows the third exemplary embodiment with the light source disposed on the second surface of the light guide layer. The reference numbers are as follows: 1: glass; 2: light isolating layer; 3: light guide layer; 6: light source; 7: light; 8: output light reorienting element; and 10: incidence reorienting element.

FIG. 6 illustrates the light path of the prism optical reorienting element. The reference numbers are as follows: 2: light isolating layer; 3: light guide layer; 6: light source; 7: light; and 10: incidence reorienting element.

FIG. 7A is a schematic diagram of the structure of the article in Example 1, wherein the reference number 11 represents a clear glass (pattern 1, F2) and 12 represents a clear glass (pattern 2, F3).

FIG. 7B is light-emitting pictures of the article in Example 1.

FIG. 8A is a schematic diagram of the structure of the article in Example 2, wherein the reference number 11 represents a clear glass (pattern 1) and 12 represents a clear glass (pattern 2).

FIG. 8B is light-emitting pictures of the article in Example 2.

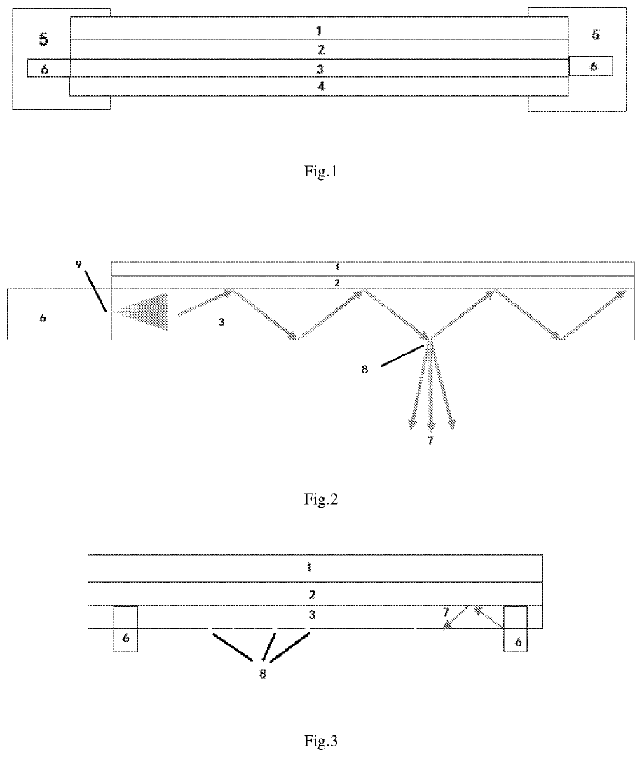

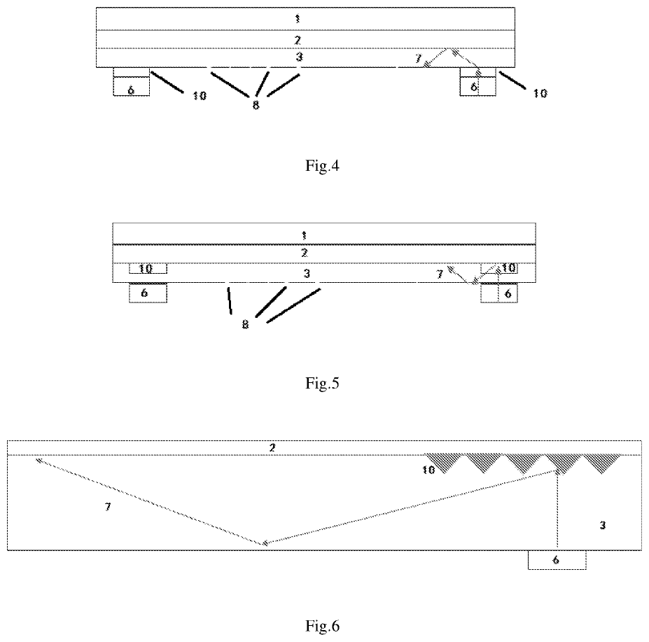

The following Examples illustrate the advantageous effects of the present application. Those skilled in the art will understand that these Examples are illustrative rather than limiting, and should not be considered to limit the scope of the present application in any way. The experimental methods described in the following Examples, unless otherwise specified, are conventional methods. Reagents and materials used are commercially available, unless otherwise specified.

### DETAILED DESCRIPTION OF THE PREFERRED EMBODIMENT

### Example 1

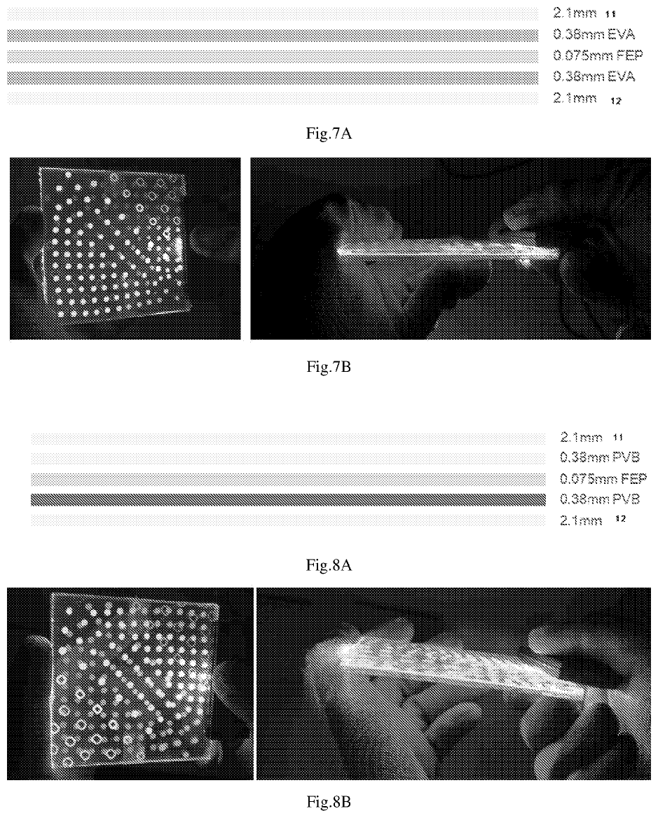

As shown in FIG. 7A, two rectangular sheet glasses were taken, the sheet glasses having a length and a width of 100 mm and 100 mm respectively, a thickness of 2.1 mm, a light transmittance of about 91-93%, and a refractive index of about 1.51. Then, an array of light-emittable ink dots with an appropriate size was printed on one surface of each of the two sheet glasses, respectively. The two sheet glasses were placed with the ink-printed surface facing each other and laminated with adhesives in sequence therebetween as follows: a first EVA layer (ethylene-vinyl acetate copolymer, having a refractive index after curing about 1.48-1.49 and a thickness of 0.38 mm), an FEP film (fluorinated ethylene propylene copolymer film, having a refractive index of about 1.34) with a thickness of 0.075 mm, and a second EVA layer. After completion, the multi-layer structure was compressed tightly.

Subsequently, the obtained article was placed in a vacuum to subject to a heat treatment, wherein the temperature is 125° C. and the duration is 1 hour. EVA in the article was cured and bonded. The obtained article had a stable multi-layer structure.

On the side surface of the upper sheet glass of the multi-layer structure obtained after the heat treatment, a light source was disposed. By removing part of the material by means of laser on one end surface of the glass layer, a light inlet was disposed. The propagation and emitting of the light was observed, and the results were shown in FIG. 7B. As can be seen from FIG. 7B, when the light source was introduced into the upper sheet glass from the side surface, the brightness of the upper glass and the upper EVA coating was significantly higher than that of the lower glass and the lower EVA coating. Moreover, the array of the light-emittable ink dots of the upper glass was significantly lit, while it was difficult to observe obvious emitted light from the array of the light-emittable ink dots of the lower glass.

This Example demonstrates that, the use of intermediate FEP film as a light isolating layer can well coordinate with the light guide layer, allowing the light in the light guide layer to propagate in a total reflection manner.

### Example 2

As shown in FIG. 8A, two rectangular sheet glasses were taken, the sheet glasses having a length and a width of 100 mm and 100 mm respectively, a thickness of 2.1 mm, a light transmittance of about 91-93%, and a refractive index of about 1.51. Then, an array of light-emittable ink dots with an appropriate size was printed on one surface of each of the two sheet glasses, respectively. The two sheet glasses were placed with the ink-printed surface facing each other and laminated with adhesives in sequence therebetween as follows: a first PVB layer (polyvinyl butyral, having a refractive index after curing about 1.48 and a thickness of 0.38 mm), an FEP film (fluorinated ethylene propylene copolymer film, having a refractive index of about 1.34) with a thickness of 0.075 mm, and a second PVB layer. After completion, the multi-layer structure was compressed tightly.

Subsequently, the obtained article was placed in a vacuum to subject to a heat treatment at the temperature of 125° C. for 0.5 hour, followed by in an autoclave under the pressure of 1.3 MPa at the temperature of 135° C. for 2 hours. The obtained article had a stable multi-layer structure.

On the side surface of the upper sheet glass of the multi-layer structure obtained after the heat treatment, a light source was disposed. By removing part of the material by means of laser on one end surface of the glass layer, a light inlet was disposed. The propagation and emitting of the light was observed, and the results were shown in FIG. 8B. As can be seen from FIG. 8B, when the light source was introduced into the upper sheet glass from the side surface, the brightness of the upper glass and the upper PVB coating was significantly higher than that of the lower glass and the lower PVB coating. Moreover, the array of the light-emittable ink dots of the upper glass was significantly lit, while it was difficult to observe obvious emitted light from the array of the light-emittable ink dots of the lower glass.

This Example demonstrates that the use of intermediate FEP film as a light isolating layer can well coordinate with the light guide layer, allowing the light in the light guide layer to propagate in a total reflection manner.

1. A light-emittable glass-based article, including:
a glass, having two opposing sides and a thickness defining a distance between the two sides, and, having a length and a first end surface and a second end surface defining the length;
a light isolating layer disposed on one side of the glass, the light isolating layer having a length and a first end surface and a second end surface defining the length;
a light guide layer disposed on the light isolating layer, the light guide layer including a first surface and a second surface opposite to the first surface, and a thickness defining a distance between the first surface and the second surface, and the light guide layer having a length and a first end surface and a second end surface defining the length, wherein the light guide layer is disposed on the light isolating layer through the first surface and allows light to propagate therein in a total reflection manner; and
the light guide layer further includes an output light reorienting element for guiding light out of the light guide layer.

2. The glass-based article according to claim 1, wherein the glass is a glass having a curvature and/or wherein the glass-based article further includes a light source.

3. The glass-based article according to claim 1, further including:
a light inlet, used for accepting light emitted from a light source.

4. (canceled)

5. The glass-based article according to claim 3, wherein the light inlet is on the first end surface of the light guide layer or the light inlet is on the first surface of the light guide layer.

6. (canceled)

7. The glass-based article according to claim 1, wherein the light guide layer further includes an incidence reorienting element.

8. The glass-based article according to claim 7, wherein the incidence reorienting element is a waveguide element or a prism optical reorienting element.

9. (canceled)

10. The glass-based article according to claim 1, wherein the second surface of the light guide layer contacts air or the second surface of the light guide layer is further provided with a protective layer; and/or
wherein the output light reorienting element is a structured surface, a preset pattern, a concave, and/or a convex; and/or
wherein the glass-based article has an edge encapsulation material.

11. (canceled)

12. (canceled)

13. The glass-based article according to claim 3, wherein the light inlet is on the first surface of the light guide layer, and, a distance between it and an outer side of the first end surface and/or the second end surface of the glass and/or the light isolating layer that optionally has an edge encapsulation material is greater than 0.

14. The glass-based article according to claim 3, wherein the light inlet is on the first surface of the light guide layer, and a distance between it and an inner side of the first end surface and/or the second end surface of the light guide layer is less than 2 cm.

15. The glass-based article according to claim 1, wherein the light isolating layer includes one or a combination of more of the following materials:
(1) one or more fluoropolymers, optionally one or a combination of more of ethylene-tetrafluoroethylene copolymer, fluorinated ethylene propylene copolymer, and polyvinylidene fluoride;
(2) one or more polysiloxanes, optionally one or a combination of more of silicone oil, silicone rubber, and silicon resin;
(3) one or more acrylate polymers, optionally one or a combination of more of acrylic resin, and methacrylic resin; and
(4) one or more epoxy resins, optionally one or a combination of more of bisphenol A epoxy resin, halogenated bisphenol A epoxy resin, phenolic epoxy resin, cycloaliphatic epoxy resin, bisphenol S epoxy resin.

16. The glass-based article according to claim 1, wherein the light guide layer includes one or a combination of more of the following materials:
(1) one or more polyurethanes;
(2) one or more polycarbonates;
(3) one or more acrylate polymers, optionally polymethylmethacrylate;
(4) one or more polyesters, optionally polyethylene terephthalate; and
(5) one or more cellulose acetates, optionally cellulose triacetate, more optionally cellulose acetate with a degree of esterification of greater than or equal to 2.7.

17. The glass-based article according to claim 1, wherein the light isolating layer includes one or more thermoplastic materials, and curable materials, or a combination thereof; and/or
wherein the light guide layer includes one or more thermoplastic materials, and curable materials, or a combination thereof.

18. (canceled)

19. The glass-based article according to claim 17, wherein the thermoplastic material includes one or a combination of more of polyethylene terephthalate, polybutylene terephthalate, cellulose acetate, polycarbonate, ethylene-vinyl acetate polymer, polyvinyl butyral, polyethylene, polypropylene, polyvinyl chloride, polystyrene, polyoxymethylene, polyamide, polysulfone, polyphenyl ether, and chlorinated polyether; and/or
wherein the curable material includes one or a combination of more of phenolic resin, urea formaldehyde resin, melamine resin, unsaturated polyester resin, epoxy resin, silicone resin, and polyurethane, and one or more precursor materials for producing the curable material.

20. (canceled)

21. The glass-based article according to claim 1, wherein the light isolating layer includes one or more pressure sensitive adhesives, optically transparent adhesives, and primers, or a combination thereof; and/or
wherein a material of the light guide layer includes optically transparent adhesive.

22. (canceled)

23. The glass-based article according to claim 21, wherein the pressure sensitive adhesive includes one or a combination of more of rubber pressure sensitive adhesive, polyurethane pressure sensitive adhesive, acrylate polymer pressure sensitive adhesive, and polysiloxane pressure sensitive adhesive; and/or
wherein the optically transparent adhesive includes one or a combination of more of silicone resin, epoxy resin, and acrylate.

24. (canceled)

25. The glass-based article according to claim 1, wherein a ratio of a refractive index of a material of the light guide layer to a refractive index of a material of the light isolating layer is greater than or equal to about 1.02.

26. The glass-based article according to claim 1, wherein a difference between the refractive index of the light guide layer and a refractive index of the light isolating layer is in the range from 0.01 to 0.30.

27. The glass-based article according to claim 1, wherein a refractive index of the light isolating layer is less than or equal to about 1.50, less than or equal to about 1.49, less than or equal to about 1.48, less than or equal to about 1.47, less than or equal to about 1.46, less than or equal to about 1.45, less than or equal to about 1.44, less than or equal to about 1.43, less than or equal to about 1.42, less than or equal to about 1.41, less than or equal to about 1.40, less than or equal to about 1.39, less than or equal to about 1.38, less than or equal to about 1.37, less than or equal to about 1.36, less than or equal to about 1.35, less than or equal to about 1.34, less than or equal to about 1.33, less than or equal to about 1.32, less than or equal to about 1.31, less than or equal to about 1.30, less than or equal to about 1.29, less than or equal to about 1.28, less than or equal to about 1.27, less than or equal to about 1.26, or less than or equal to about 1.25.

28. The glass-based article according to claim 1, wherein the refractive index of the light guide layer is less than or equal to about 1.80, less than or equal to about 1.79, less than or equal to about 1.78, less than or equal to about 1.77, less than or equal to about 1.76, less than or equal to about 1.75, less than or equal to about 1.74, less than or equal to about 1.73, less than or equal to about 1.72, less than or equal to about 1.71, less than or equal to about 1.70, less than or equal to about 1.69, less than or equal to about 1.68, less than or equal to about 1.67, less than or equal to about 1.66, less than or equal to about 1.65, less than or equal to about 1.64, less than or equal to about 1.63, less than or equal to about 1.62, less than or equal to about 1.61, less than or equal to about 1.60, less than or equal to about 1.59, less than or equal to about 1.58, less than or equal to about 1.57, less than or equal to about 1.56, less than or equal to about 1.55, less than or equal to about 1.54, less than or equal to about 1.53, less than or equal to about 1.52, less than or equal to about 1.51, less than or equal to about 1.50, less than or equal to about 1.49, less than or equal to about 1.48, less than or equal to about 1.47, less than or equal to about 1.46, less than or equal to about 1.45, less than or equal to about 1.44, less than or equal to about 1.43, less than or equal to about 1.42, less than or equal to about 1.41, less than or equal to about 1.40, less than or equal to about 1.39, less than or equal to about 1.38, less than or equal to about 1.37, less than or equal to about 1.36, less than or equal to about 1.35, less than or equal to about 1.34, less than or equal to about 1.33, less than or equal to about 1.32, less than or equal to about 1.31, less than or equal to about 1.30, less than or equal to about 1.29, less than or equal to about 1.28, less than or equal to about 1.27, less than or equal to about 1.26, or less than or equal to about 1.25.

29. The glass-based article according to claim 1, wherein the output light reorienting element can be disposed in the light guide layer, on the first surface of the light guide layer, or on the second surface of the light guide layer, or a combination thereof.
